(19) United States
(12) Patent Application Publication
(10) Pub. No.: US 2003/0200312 A1
(43) Pub. Date: Oct. 23, 2003

(54) COMMUNICATION SYSTEM WITH IMPROVED ACCESS NETWORK

(76) Inventor: CAREL J.L. VAN DRIEL, EINDHOVEN (NL)

Correspondence Address: CORPORATE PATENT COUNSEL, U.S. PHILIPS CORPORATION, 580 WHITE PLAINS ROAD, TARRYTOWN, NY, 10591, US

(21) Appl. No.: 09/341,085

(22) PCT Filed: Nov. 2, 1998
(86) PCT No.: PCT/IB98/01747

(30) Foreign Application Priority Data
Nov. 4, 1997 (EP) 97203416.9
Nov. 4, 1997 (EP) 97203417.7
Sep. 25, 1998 (EP) 98203229.4

(51) Int. Cl. G06F 15/173

(52) U.S. Cl. 709/225; 709/232

(57) ABSTRACT

In a communication system a network switch (4) is coupled to an access network (1) in order to enable communication between a network (2) and terminals (13) connected to the access network (1). In the prior art communication system, the network switch needs to know the details of the access network, in order to be able to deliver information to the correct terminal. This requires that a dedicated network switch (4) is used which is substantially more complex than a standard network switch. To solve this problem, an access node switch (8) is used which deals with the access network specific details. Consequently a network switch (4) can be used which operates according to standard switching protocols.

The present invention relates to a communication system comprising a plurality of terminals which are connected to a network switch via an access network, the access network comprising an access node coupled to the terminals via a transmission network, the access node further being coupled to the network switch.

The present invention also related to an access node for use in such a communication system.

A communication system according to the preamble is known from “Delivery System Architecture and Interface, DAVIC 1.3 specification, part 4, revision 6.2, Geneva 1997.

Such communication systems are proposed for providing wide band and narrow band services to a plurality of subscribers. Examples of these services are video broadcast, video on demand, telephony and fast Internet access.

In order to provide switched services, such as video on demand and telephony, the terminals are connected to the switching means via an access network. The access network comprises an access node coupled to a transmission network. The transmission network can e.g. be a bi-directional Hybrid Fiber Coax network.

A problem with the communication network according to the prior art is that the network switch needs to known all details of the access network in order to be able to deliver information to the correct terminal. Such a network switch is substantially more complex that a standard network switch, which is able to interface to the access network using a standard signaling protocol. It is observed that the access node switch is in general substantially less complex than the network switch. Consequently, the replacement of a dedicated network switch by a combination of a standard network switch and an access node switch still results in a substantial overall reduction of the complexity of the communication system.

The object of the present invention is to provide a communication network according to the preamble in which standard switching means can be used.

To achieve said object, the communication system according to the invention is characterized in that the access node comprises an access node switch and a plurality of network control elements, in that the access node switch is coupled to the network switch and to the plurality of network control elements, in that the transmission network comprises a plurality of sub-networks, and in that the network control elements are coupled to the plurality of sub-networks.

By using an access node switch for coupling the switching means to the plurality of network control elements which control a corresponding sub-network, all access network specific issues can be dealt with by the access node switch. Consequently, the network switching means can operate according to a standard signaling protocol.

An embodiment of the present invention is characterized in that the network control elements comprise a network control switch and a plurality of channel cluster modules, in that the network control switch is coupled to the access node switch and to the channel cluster modules, and in that the channel cluster modules are coupled to the sub-network corresponding to the network control node.

By introducing a network control switch between the access node switch and the channel cluster modules, details such as carrier frequencies allocated to the terminals need not to be known at the level of the access node switch. This leads to a simplification of the access node switch.

The channel cluster modules comprise a downstream channel module for transmitting a signal on a carrier frequency allocated to a terminal in the present sub-network. Optionally, the channel module comprises one or more upstream channel modules, in order to receive information at an upstream frequency from a terminal in the sub-network.

A further embodiment of the invention is characterized in that the terminals comprises signaling means for exchanging network layer control information with the network switch.

By using signaling means which can exchange network layer control information, said network layer control information can be exchanged transparently over the access network between the terminal and the network switch.

An alternative embodiment of the invention is characterized in that the network switch comprises proxy signaling means for deriving network layer control information from session layer and/or transport layer information exchanged between a terminal and the network switch.

By using proxy signaling means in the network switching means for deriving network layer control information from session and/or transport layer information, it is obtained that the terminals can be simplified at the cost of a small complexity increase of the network switching means. Due to the large number of terminals, this measure results in a decreased cost of the communication system.

The present invention will now be explained with reference to the drawing figures.

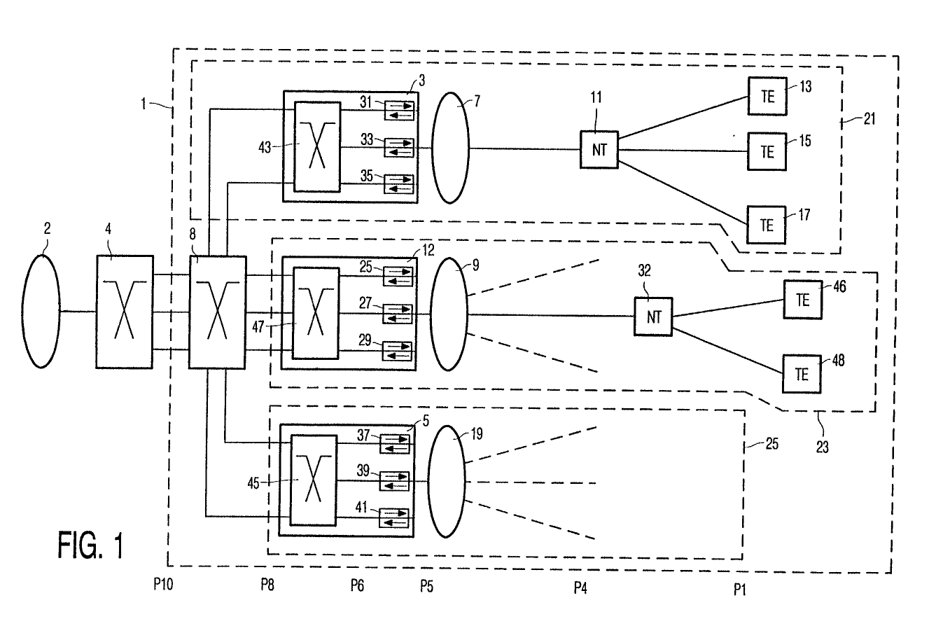

FIG. 1 shows a communication network according to the invention.

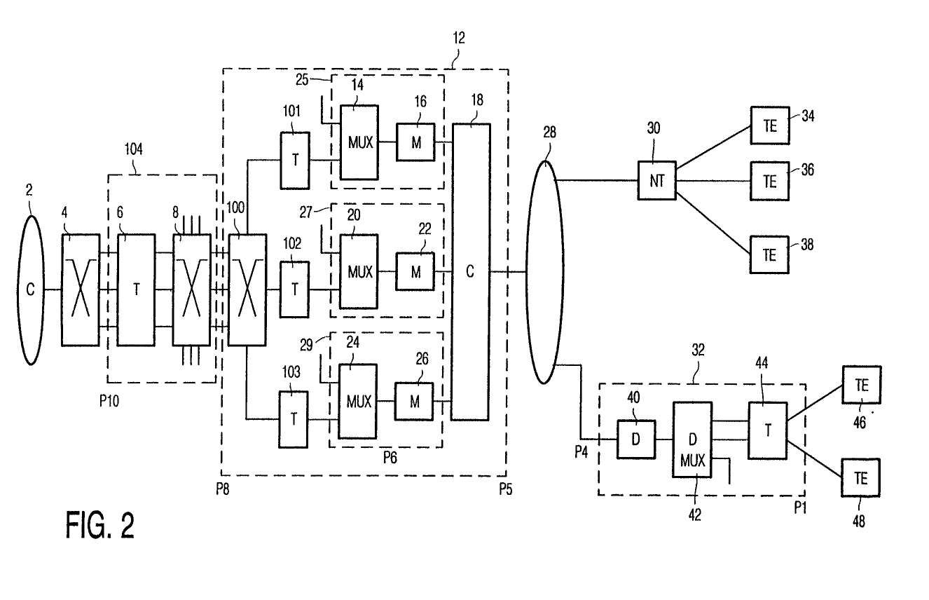

FIG. 2 shows the downstream elements in a communication network according to the invention.

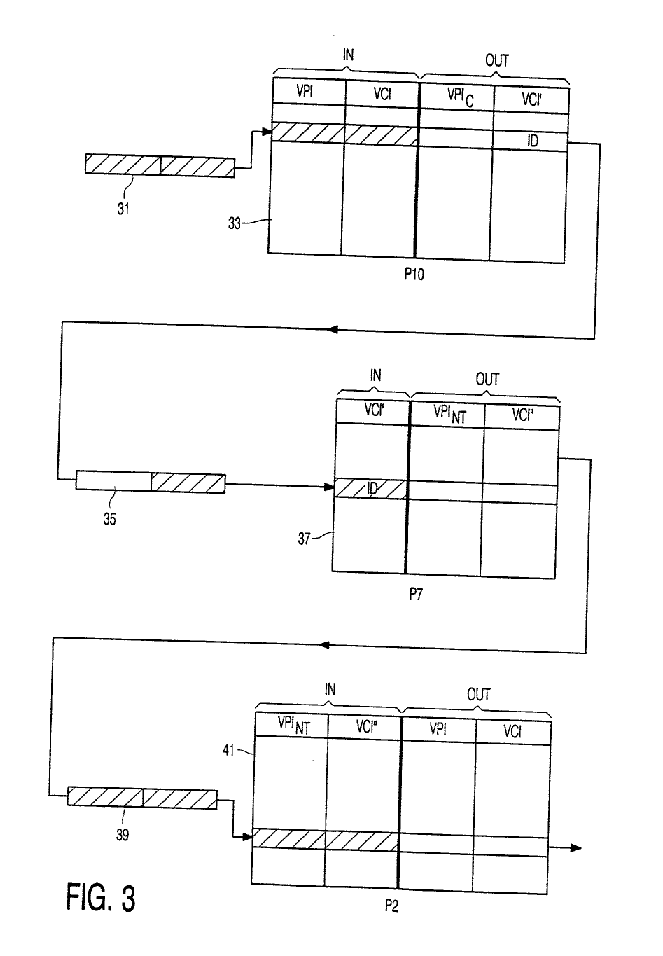

FIG. 3 shows a diagram explaining the address translations to which an ATM cell is subjected when it is transmitted from the core network 2 to the terminal 46.

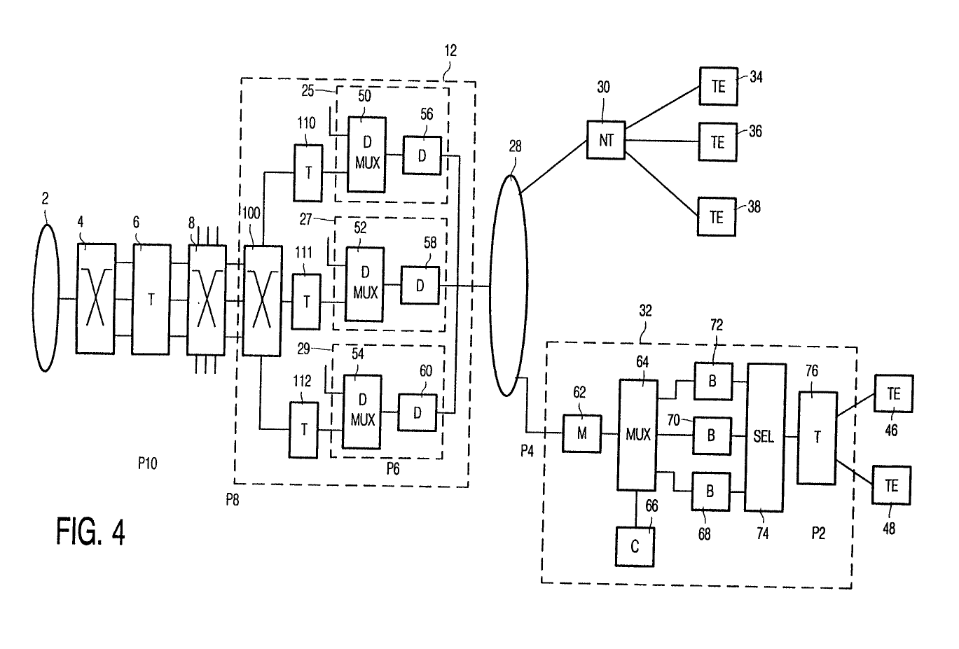

FIG. 4 shows the upstream elements in a communication network according to the invention.

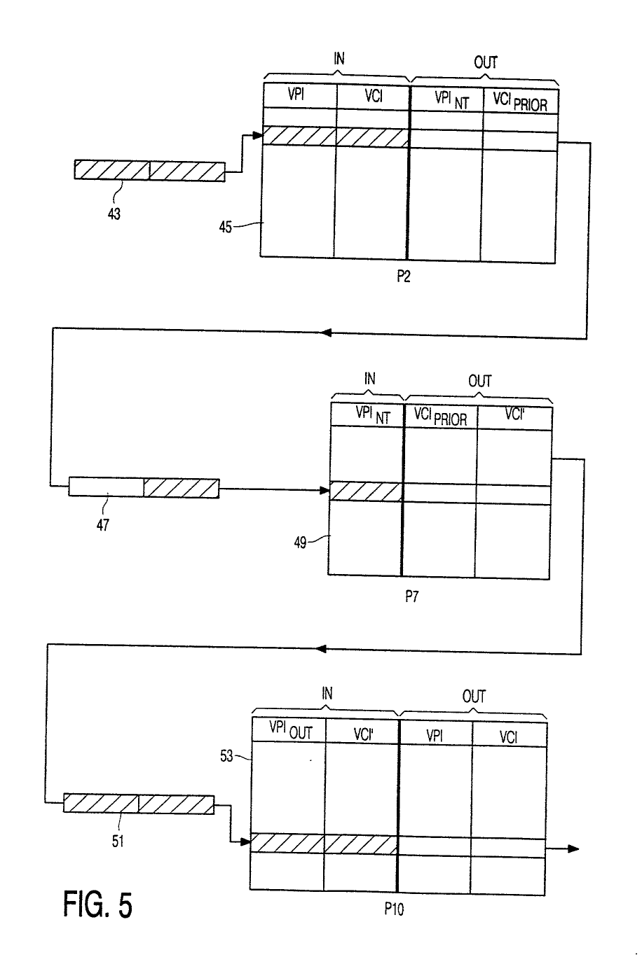

FIG. 5 shows a diagram explaining the address translations to which an ATM cell is subjected when it is transmitted from the terminal 46 to the core network 2.

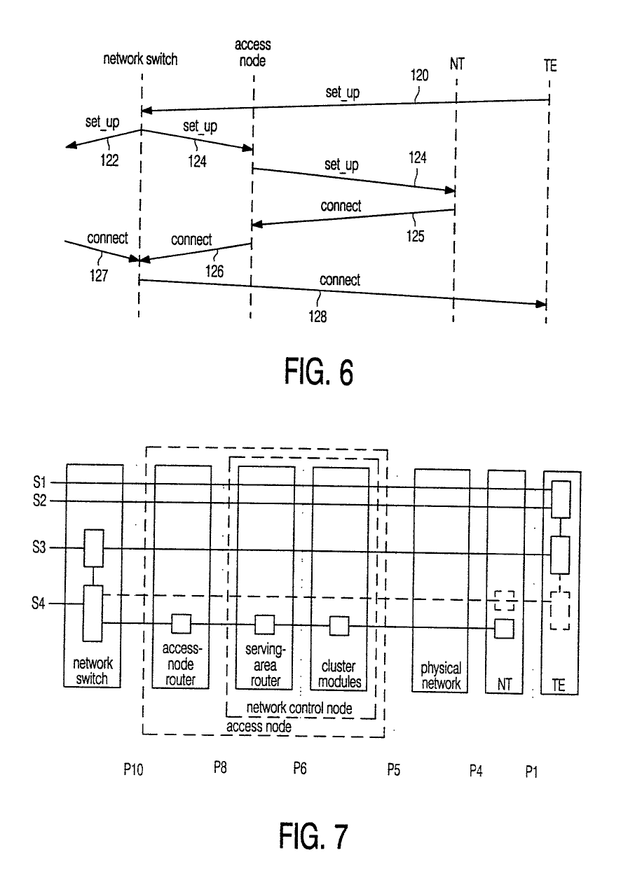

FIG. 6 shows the set-up of a connection in a communication system according to the invention.

FIG. 7 shows the signal flow in a network according to the invention.

The communication network according to FIG. 1 comprises an access network 1 which is connected to a core network 2 via the network switch 4. The access network comprises a plurality of service areas 21, 23 and 25. The network switch 4 is coupled to said service areas 21, 23 and 25 via the network control switch which is here a cross-connect 8. Each of the service areas 21, 23 and 25 comprises a corresponding Network Control Node 3, 12 and 5 respectively. The network control nodes 3, 12 and 5 are coupled to the respective sub-networks 7, 9 and 19, which can comprise a Hybrid Fiber Coax network (HFC), which type of network is presently extensively used for CATV transmission.

The network control nodes 3, 5 and 12 comprise a network control switch 43, 45 and 47. The network control switches 43, 45 and 47 are coupled to the access node switch 8. The network control switch 43 is coupled to channel cluster modules 31, 33 and 35. The network control switch 47 is coupled to channel cluster modules 25, 27 and 29. The network control switch 5 is coupled to channel cluster modules 37, 39 and 41. Each of the channel cluster modules is arranged for transmitting downstream signals on one carrier frequency. Optionally the channel cluster modules can receive one or more upstream signals.

The Network Control Nodes 3, 5 and 12, transform the signals received from the cross connect 8 into signals modulated on separate carriers for transmission into the corresponding HFC network. The network control switches are arranged for routing the signals received from the access node switch 8 to the correct channel cluster module in the network control node. In the sub networks 7, 9 and 19, a number of carriers e.g. 128 are available for transmission signals to the network terminations (NT). Each of the channel cluster modules present in the network control node has one of these 128 carriers assigned to it.

One of the network terminations 11 is drawn in FIG. 1. Each NT is arranged for receiving one of said carriers used in the HFC network. The network termination 11 is arranged for passing the signals received from the HFC network to the terminals 13, 15 and 17. In each service area the same carrier frequencies can be re-used because there is no connection between the HFC networks of different service areas.

The network terminations 11 and 32 are arranged for passing signals from their terminals 13, 15, 17 and 46, 48 respectively via an upstream carrier via the HFC network 7, 9 to the corresponding Network Control Node 3, 12. In order to be able to use the HFC network for upstream transmission an access protocol such as described in IEEE 802.14, DVB or DAVIC should be used. It is observed that it is possible that the function of the NT and the terminal TE are integrated in one device. This is e.g. possible when the combination of NT and TE are present on a PC add-on card for use in personal computers.

In FIG. 2, the downstream elements used in the network according to FIG. 1 are drawn in more detail. The core network 2 is a public broadband network that can be based on ATM. The switch 4 is arranged for setting up connections between subscribers connected to the core network and subscribers connected to the access network 1. The switch 4 is also arranged for setting up local connections between subscribers both connected to the access network 1. The address information contained in the ATM cells entering and leaving the switch 4 is according to the addressing scheme used on the core network 2.

The switch 4 is further connected to a cross-connect 8, which is arranged for directing the ATM cells into the proper parts in the access network. In order to enable the cross connect to direct the ATM cells to the proper parts of the network, at an interface P10 the address of the ATM cell is translated by a translator 6. The address carried by ATM cells at the input of the translator 6 is translated into an address comprising a VPI identifier identifying the service area to which the cell should be routed and which carrier should be used in said service area. This translation is performed by reading a table, which is addressed with the original VPI/VCI identifier of the ATM packet.

In general, the table in translator 6 is updated each time a connection is set up or is disconnected. During the set up of a call a table entry with input value the VPI/VCI identifier of the terminal to be called is added. The corresponding output value comprises information about the service area and the carrier to be used in the VPI field, and an identification of the terminal to be addressed in the VCI field.

The cross connect 8 reads the VPI field of the incoming ATM packets, and routes it to an output determined by the part of the VPI value indicating the service area. In the system according to FIG. 2, outputs of the cross connect 8 are connected to the network control elements of which network control element 12 and the corresponding part of the system are shown. In the network control element 12, the input is connected to the network control switch 100. The network control switch 100 routes the signals received from the cross connect 8, via a translation unit 101, 102 or 103 to one of the channel cluster modules 25, 27 or 19. The channel module to be chosen is indicated by the part of the VPI field in the received packets indicating the channel cluster module to be used. The address translation units 101, 102 and 103 replace the combination of VPI/VCI by a new combination of VPI/VCI that is determined from the original VCI value only. This translation enables a more flexible addressing, because a larger address space is available.

In the new combination of VPI/VCI, the VPI field is used to address the network terminator to which the destination terminal is connected. The VCI field identifies the destination terminal.

In the channel cluster module 25, the ATM packet with the translated address information, is passed via a multiplexer 14 to a modulator 16 having a predetermined carrier frequency. The selection of the service area and the modulator (is selection of carrier frequency) therein is done on basis of the output VPI value at interface P10. The multiplexer 14 is present to enable the Network Control Node 12 to transmit control information to the corresponding Network Termination. The output signal of the selected modulator (e.g. 22) is combined with the output signals of the other modulators (e.g. 22 and 26) and transmitted via the coax network 28 to the network terminations 30, 32.

The network terminations 30, 32 demodulate and process the signal received at the carrier frequency assigned to them. In the network termination 32 a demodulator 40 demodulates the signal received from the HFC network 28. A demultiplexer 42 connected to the demodulator 40 extracts control information intended for control of the Network Termination 32. A plurality of outputs of the demultiplexer 42 is connected to the additional address translating means, being here an address translator 44. This address translator 44 translates the VPI/VCI combination introduced by the address translator 10 into the addresses as they were received from the core network. Subsequently the packets are transmitted to the terminals 46 and 48.

If the VPI field is 12 bits and the VCI is 16 bits as is the case for ATM cells for use on Network-Network Interfaces 12 bits are available for identifying the Service Area and the carrier frequency to be used therein. If the network comprises 32 service areas, 128 carrier frequencies can be defined. For each of the service areas 12 bits are available for identifying the network termination and 16 bits are available for identifying the terminal. Consequently 4096 network terminations and 65536 terminals can be addressed in each service area.

Without the address translation at interface P10, 16 bits would be available for addressing the network terminations and the terminals. If in such a case 4096 NT's had to be addressed, only 16 terminals could be selected with the remaining address space.

Consequently only 16 terminals could be connected to one Network Termination. By using the address translation according to the invention 65536 terminals can be in a connection, without any constraint to the network termination they are connected to. If the address translations were dispensed with, a more simple solution would be obtained. This could be advantageous when simple networks have to be built.

FIG. 3 shows the sequence of address translation to which an ATM packet is subjected when traveling from the core network to a terminal. A packet from the core network 2 has a VPI/VCI part 31 as is shown in FIG. 3. At the interface P10 this VPI/VCI part is translated into a VPI_{C}/VCI′ part 35. This translation is performed by addressing a table 33 with the VPI/VCI part as input signal and reading the VPI_{C}/VCI′ part from the output of the table 33. The table 33 is held by the translation means 6 in FIG. 2. As can be seen in FIG. 3 the complete address information VPI/VCI is used for addressing the table 33.

The VPI_{C} part of the address information 35 is used to route the ATM packet to the proper service area and modulator. The VCI′ part of the address information is used as input for the translation of the address information at interface P7. The VCI′ part is used to address a table 37 from which the translated address information VPI_{NT}/VCI″ is read. The table 37 is held in the translation means 10 in FIG. 2. The part VPI_{NT} indicates the address of the NT to which the destination terminal is connected, and the part VCI″ indicates the address of the destination terminal.

The combination 39 of the address information VPI_{NT}/VCI″ is used as input for the address translation at interface P2. Said combination of VPI_{NT}/VCI″ is used to address a table 41 which is held in the translator 44 in FIG. 2. At the output of the table the VPI/VCI combination according to the addressing scheme of the core network is available for addressing the terminal.

FIG. 4 shows the elements involved with the upstream transmission for a communication network according to FIG. 1. An ATM packet originated at a terminal 46 or 48 is applied to an address translator 76. The address translator 76 in the network termination 32 translates the original address information VPI/VCI into translated address information VPI_{NT}/VCI_{PRIOR}.

The part VPI indicates the Network Termination 32 via which the packet is transmitted. According to an aspect of the present invention, the part VCI_{PRIOR} indicates the Quality of Service with which the ATM packet has to be transmitted. A selector 74 selects the ATM packets received from the translator 76 and passes them to one of the buffers 68, 70 or 72 according to their VCI_{PRIOR} indicator. The buffer 68 can be assigned to a Constant Bitrate QoS (CBR) with a high bitrate, the buffer 70 can be assigned to a Constant Bitrate QoS (CBR)with a medium bitrate, and the buffer 72 can be assigned to a Variable Bitrate (VBR) QoS.

A CBR QoS with high bitrate is e.g. suitable for transmission of video signals, a CBR QoS with medium bitrate is e.g. suitable for transmission of audio signals, and a VBR QoS is suitable for the transmission of data which occurs e.g. with file transfer. The ATM packets at the output of the buffers 68, 70 and 72 are multiplexed with a multiplexer 64 into an output stream. The multiplexer takes the different QoS properties of the output signals of the buffers 68, 70 and 72 into account, by transmitting the packets according to a priority which is dependent on the buffer from which the packet is read. It is clear that the buffers carrying CBR signals have a higher priority than the buffers carrying VBR signals. Amongst the buffers carrying CBR signals, the buffers assigned to high bitrate streams have the highest priority. Besides the signals from the buffers 68, 70 and 72, also a control signal from the network termination 32 is applied to an input of the multiplexer, in order to be transferred to the network control node 12.

The output signal of the multiplexer 64 is modulated by a modulator 62 on a carrier with a frequency that is assigned to the network termination 32. The network termination 32 transmits the output signal of the multiplexer 62 via the network 28 to the network control node 12. In the network control node, the signal received from the network 28 is applied to the channel cluster module 27. In the channel cluster module 27, the received signal is demodulated in demodulator 58 and demultiplexed by the corresponding demultiplexer 52. The control information from the network termination 32 is available at a separate output of the demultiplexer for further use in the network control node 12.

The outputs of the demultiplexers 50, 52 and 54 in the channel cluster modules 25, 27 and 29 connected to corresponding inputs of address translators 110, 111 and 112. These address translators translates the combination of VPI_{NT}/VCI_{PRIOR} into new address information VPI_{OUT}/VCI′. This translation is obtained by reading a table entry using the VCI_{PRIOR} indication as entry. The ATM cells at the output of the address translator 110, 111 and 112 are passed to the crossconnect 8 via the network control switch 100. The outputs of the cross connect 8 are connected to corresponding inputs of address translation means 6. The address translating means 6 translates the combination of VPI_{OUT}/VCI′ into the original destination address VPI/VCI of the packet. The packet with the original address VPI/VCI is transferred to the switch 4 in order to transmit the packet to the core network 2.

FIG. 5 shows schematically the sequence of address translation to which an ATM packet is subjected when traveling from a terminal 46 or 48 to the core network. A packet from the terminal 46 or 48 has a VPI/VCI part 43 as is shown in FIG. 5. At the interface P2 this VPI/VCT part is translated into a VPI_{NT}/VCI_{PRIOR} part 47. This translation is performed by addressing a table 45 with the VPI/VCI part as input signal and reading the address information VPI_{NT}/VCI_{PRIOR} from the output of the table 45. The table 45 is held by the translation means 76 in FIG. 5. As can be seen in FIG. 5 the complete address information VPI/VCI is used for addressing the table 45.

The VPI_{PRIOR} part of the address information 47 is used to route the ATM packet to the Network Control Node 12 via a path being able to provide transmission according to the proper Quality of Service indicated by the address part VCI′. The VCI′ part of the address information is used as input for the translation of the address information.

At interface P7, the VCI′ part of the address information 47 is used to address a table 49 from which the translated address information VPI_{OUT}/VCI′ is read. The table 49 is held in the translation means 10 in FIG. 4. The part VPI_{OUT} indicates the output of the cross connect 8 to which the packet should be transferred.

The combination 51 of the address information VPI_{OUT}/VCI′ is used as input for the address translation at interface P10. Said combination of VPI_{OUT}/VCI′ is used to address a table 53 which is held in the translator 6 in FIG. 4. At the output of the table 53 the VPI/VCI combination according to the addressing scheme of the core network is available for submitting the packet to the switch 4.

It is observed that the address translation at the interfaces P10, P8 and P2 are very similar for upstream and downstream. This enables that the translation units 6, 10 and 76 can be used for downstream and upstream traffic and in that the method comprises translating the address information before the packets enter the crossconnect 8.

In the diagram according to FIG. 6, it is assumed that a request for a connection is initiated by a terminal. Due to the transparent connection between the terminal and the network switch the terminal sends a set-up message 120 to the network switch 4. In response to said set-up message 120, the network switch issues a set-up message 122 to the public network it is connected to, and a set-up message 123 to the access node. The access node reserves resources for handling the requested call, and subsequently submits a set-up message 124 to the NT.

The NT replies to the set-up message 124 by transmitting a connect message 125 to the access node to indicate that the connection has been established. The access node submits in response to the connect message 125 received from the NT, a connect message 126 to the network switch 4, for indicating the connection establishmnent.

When the network switch 4 has received the connect message 126 from the NT and the connect message 127 from the public network, a connect message 128 is sent to the terminal indicating that the connection has been established.

If the connection requested by the terminal is a connection with a local terminal, the network switch 4 sends two set-up command to the access node for setting up a connection between the network switch and the NT's to which the calling and the called terminals are connected. The connect message 128 to the calling terminal is issued when a connect message from both involved NT's are received.

FIG. 7 shows the different signal flows present in the system according to the invention in relation to the several interfaces used therein. The S1 flow and the S2 flow constitute the user data flow. The S1 flow comprises the content data flow carrying the actual content, and the S2 flow comprises the content data control flow carrying control signals directly related to the content. The S1 and S2 flow are transported transparently over the network. The S1 and S2 flow are terminated in two interconnected terminals, or in the terminal and in a server to which the terminal is connected.

The S3 flow and the S4 flow are involved with the control of the connections. The S3 flow exchanges information between peer entities in the Session and Transport layers of the layered OSI representation of communication systems. The S3 flow is related to establishing, modifying and terminating sessions, and also to negotiation on resource requirements. The S4 flow is defined between peer objects in the network service layer and is related to establishment and release of connections, port information, QoS negotiation and modifications of connections and routing data. The S3 flow is terminated in the terminal and in the network switch.

With respect to the implementation of the S4 flow, there exist two possibilities. A first possibility is that the terminal TE does not have S4-flow capability. This makes the terminal simpler, but the network switch needs to have a proxy signaling function, which derives S4 signals for the several network elements from the S3 flow exchanged between the terminal and the network switch. In this case the S4 flow is terminated in the network switch, the access node router, the service area router, the cluster modules and in the network termination.

A second possibility is that the terminal does include S4 signaling capabilities. In this case, the proxy signaling function in the network switch is not required. In the second case, the S4 flow is terminated also in the terminal 4.

1. Communication system comprising a plurality of terminals which are connected to a network switch via an access network, the access network comprising an access node coupled to the terminals via a transmission network, the access node further being coupled to the network switch, characterized in that the access node comprises an access node switch and a plurality of network control elements, in that the access node switch is coupled to the network switch and to the plurality of network control elements, in that the transmission network comprises a plurality of sub-networks, and in that the network control elements are coupled to the plurality of sub-networks.

2. Communication system according to claim 1, characterized in that the network control elements comprise a network control switch and a plurality of channel cluster modules, in that the network control switch is coupled to the access node switch and to the channel cluster modules, and in that the channel cluster modules are coupled to the sub-network corresponding to the network control node.

3. Communication system according to claim 2, characterized in that the channel cluster modules comprise at least one downstream channel module.

4. Communication system according to claim 3, characterized in that the channel cluster module comprises an upstream channel module.

5. Communication system according to one of the claims 1, 2, 3 or 4, characterized in that the terminals comprises signaling means for exchanging network layer control information with the network switch.

6. Communication system according to one of the claims 1, 2, 3 or 4, characterized in that the network switch comprises proxy signaling means for deriving network layer control information from session layer and/or transport layer information exchanged between a terminal and the network switch.

7. Access node coupled being connectable to a transmission network, and to a network switch, characterized in that the access node comprises an access node switch being coupled to a plurality of network control elements, in that the access node switch is connectable to the network switch and in that the network control elements are connectable to a plurality of sub-networks.

8. Access node according to claim 7, characterized in that the network control elements comprise a network control switch and a plurality of channel cluster modules, in that the network control node router is coupled to the access node router and to the channel cluster modules, and in that the channel cluster modules are connectable to a sub-network corresponding to the network control node.
